(19) United States
(12) Patent Application Publication
(10) Pub. No.: US 2002/0035703 A1
(43) Pub. Date: Mar. 21, 2002

(54) Electronic apparatus and processing ability alteration instruction apparatus

(76) Inventor: Yosuke Konaka, Kawasaki (JP)

Correspondence Address: STAAS & HALSEY LLP, 700 11TH STREET, NW, SUITE 500, WASHINGTON, DC, 20001, US

(21) Appl. No.: 09/781,324

(22) Filed: Feb. 13, 2001

(30) Foreign Application Priority Data
Sep. 18, 2000 (JP) 2000-281865

(51) Int. Cl. G06F 1/26; G06F 1/28; G06F 1/30

(52) U.S. Cl. 713/330

(57) ABSTRACT

An electronic apparatus to which a plurality of batteries are detachably mounted, has a removal requirement receipt section for receiving a removal requirement for a part of the mounted batteries, a processing ability determination section responsive to the removal requirement for a battery from said removal requirement receipt section for determining whether a supplying possible electric power from the remaining batteries is an electric power capable of maintaining a processing ability or an electric power which needs to lower the processing ability, and a processing ability control section for lowering the processing ability in accordance with a decision from said processing ability determination section that the electric power needs to lower the processing ability.

### BACKGROUND OF THE INVENTION

1. Field of the Invention

The present invention relates to an information processing apparatus or an electronic apparatus in which a plurality of batteries are able to be simultaneously mounted or are detachably mounted, and a processing ability alteration instruction apparatus for instructing an information processing ability or an alteration of the information processing ability to the information processing apparatus or the electronic apparatus.

2. Description of the Related Art

Recently, there is remarkably developed an electronic apparatus such as a portable type of information processing apparatus and a communication apparatus, for example, a notebook type of personal computer and a portable telephone. Of those apparatuses, there are ones in which a plurality of detachable secondary batteries are mounted so that a voltage is simultaneously supplied from the plurality of secondary batteries.

In case of the electronic apparatus such as an information processing apparatus in which a plurality of secondary are able to be mounted thereon, as mentioned above, the reason why a plurality of batteries are simultaneously mounted is that a life time of the batteries is considered. That is, it is considered that there is used a secondary battery having an ability of driving the electronic apparatus such as the information processing apparatus even if only one secondary battery is mounted and the residual electric power of the mounted secondary battery is considerably lowered.

The secondary battery having such a high ability is large in size and thus is an obstacle to a miniaturization of an electronic apparatus such as an information processing apparatus. In the event that a secondary battery, which is low in an ability of current supply, is used for the purpose of contributing to miniaturization, while the apparatus stably operates in a state that a plurality of such secondary batteries are mounted, there is a possibility that the apparatus is unstable in operation when a part of the secondary batteries is removed. This causes not only the loss of a merit of such an arrangement that a plurality of secondary batteries are detachably mounted independently, but also an unstable operation. Thus, there is a problem that disappearance and damage of data will occur.

### SUMMARY OF THE INVENTION

In view of the foregoing, it is an object of the present invention to provide an electronic apparatus such as an information processing apparatus in which a plurality of batteries are able to be simultaneously mounted or are detachably mounted independently, wherein there is provided such an arrangement that batteries, which are low in a current supply ability, are mounted, and the electronic apparatus has a function that even if part of the batteries is removed, the electronic apparatus is stably operative, and a processing ability alteration instruction apparatus for instructing an alteration of the information processing ability to the electronic apparatus such as the information processing apparatus.

To achieve the above-mentioned objects, the present invention provides a first electronic apparatus to which a plurality of batteries are detachably mounted, comprising:

a removal requirement receipt section for receiving a removal requirement for a part of the mounted batteries;

a processing ability determination section responsive to the removal requirement for a battery from said removal requirement receipt section for determining whether a supplying possible electric power from the remaining batteries is an electric power capable of maintaining a processing ability or an electric power which needs to lower the processing ability; and

a processing ability control section for lowering the processing ability in accordance with a decision from said processing ability determination section that the electric power needs to lower the processing ability.

The first electronic apparatus of the present invention as mentioned above has a function of reducing a consumed electric power by lowering the processing ability, in which the processing ability is lowered, as an occasion arises, upon receipt of a removal requirement for a part of the mounted batteries. This feature makes it possible to use batteries which are lower in a current supplying ability as compared with the conventional one, and also to continue stably an operation of the apparatus even if a part of the batteries is removed.

To achieve the above-mentioned objects, the present invention provides a second electronic apparatus to which a plurality of batteries are detachably mounted, comprising:

a removal requirement receipt section for receiving a removal requirement for a part of the mounted batteries; and

a processing ability control section responsive to the removal requirement for a battery from said removal requirement receipt section for lowering a processing ability.

The second electronic apparatus of the present invention as mentioned above has, in a similar fashion to that of the first electronic apparatus, a function of reducing a consumed electric power by lowering the processing ability, in which the processing ability is lowered, as an occasion arises, upon receipt of a removal requirement for a part of the mounted batteries. This feature makes it possible, in a similar fashion to that of the first electronic apparatus, to use batteries which are lower in a current supplying ability as compared with the conventional one, and also to continue stably an operation of the apparatus even if a part of the batteries is removed.

To achieve the above-mentioned objects, the present invention provides a third electronic apparatus to which a plurality of batteries are detachably mounted, comprising:

a mounting and removal detection section for detecting mounting and removal of batteries; and

a processing ability control section responsive to a detection of a removal of a battery by said mounting and removal detection section for lowering a processing ability.

The third electronic apparatus of the present invention as mentioned above has, in a similar fashion to that of the first and second electronic apparatuses, a function of reducing a consumed electric power by lowering the processing ability, in which the processing ability is lowered in accordance with a detection of a removal of the mounted battery. This feature makes it possible also to use batteries which are lower in a current supplying ability as compared with the conventional one, and also to continue stably an operation of the apparatus even if a part of the batteries is removed.

In any of the first to third electronic apparatuses as mentioned above, it is preferable that said electronic apparatus has a portion receiving a clock and operative in synchronism with the clock while consuming an electronic power according to a repetitive frequency of the clock,

wherein said processing ability control section changes over the frequency of the clock to control the processing ability.

Alternatively, it is acceptable that the processing ability is lowered by an intermittent operation, and thereby reducing the average consumed electric power.

In the first electronic apparatus according to the present invention as mentioned above, it is preferable that said processing ability determination section receives the removal requirement for a battery from said removal requirement receipt section and determines whether an electric power supplying ability is insufficient with only the remaining batteries, even if the processing ability is lowered by said processing ability control section, and

said electronic apparatus further comprises a removal acceptance display section for displaying inhibit or acceptance of the removal of a battery according as said processing ability determination section determines whether an electric power supplying ability is insufficient with only the remaining batteries, even if the processing ability is lowered by said processing ability control section.

In the second electronic apparatus according to the present invention as mentioned above, it is preferable that the second electronic apparatus further comprises:

a processing ability determination section responsive to the removal requirement for a battery from said removal requirement receipt section for determining whether an electric power supplying ability is insufficient with only the remaining batteries, even if the processing ability is lowered by said processing ability control section, and

a removal acceptance display section for displaying inhibit or acceptance of the removal of a battery according as said processing ability determination section determines whether an electric power supplying ability is insufficient with only the remaining batteries, even if the processing ability is lowered by said processing ability control section.

An adoption of the removal acceptance display section makes it possible to readily confirm whether the stable operation is ensured after the battery is removed.

In any one of the first and second electronic apparatus as mentioned above, it is preferable that the electronic apparatus further comprises a residual electric power monitor section for monitoring a residual electric power of the mounted batteries.

In the electronic apparatus as mentioned above, it is acceptable that said residual electric power monitor section measures voltage and supplying current of the mounted batteries and determines a residual electric power of the batteries through an arithmetic operation.

An adoption of the residual electric power monitor section makes it possible to properly confirm whether the stable operation is ensured after a part of the batteries is removed.

In any of the first to third electronic apparatuses as mentioned above, it is acceptable that each of said batteries is a chargeable secondary battery provided in a battery pack, and a plurality of such battery packs are capable of being mounted on said electronic apparatus.

In any of the first to second electronic apparatuses as mentioned above, it is preferable that each of said batteries is a battery provided in a battery pack, a plurality of such battery packs are capable of being mounted on said electronic apparatus, and each of said battery packs has a memory for storing a residual electric power of a battery of an associated battery pack.

An adoption of such a memory makes it possible to store therein the residual electric power, and whereby the residual electric power can be readily recognized when the battery is mounted again.

In any of the first and second electronic apparatuses as mentioned above, wherein the electronic apparatus further comprises a residual electric power monitor section, it is preferable that each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and

wherein said residual electric power monitor section measures voltage and supplying current of the mounted batteries and determines a residual electric power of the batteries referring to said memories.

According to the electronic apparatus as mentioned above, the memory stores an association between voltage and supplying current of an associated battery and a residual electric power of the battery, and the residual electric power is determined referring to the memory. This feature makes it possible to determine the residual electric power with greater accuracy.

Further in any of the first and second electronic apparatuses as mentioned above, it is preferable that each of said batteries is a battery provided in a battery pack, a plurality of such battery packs are capable of being mounted on said electronic apparatus, and each of said battery packs has a memory for storing an association between a residual electric power of an associated battery and a maximum chargeable current, and

wherein said processing ability determination section performs a determination referring to said memories.

Storage of the maximum chargeable current makes it possible to recognize the maximum chargeable current of the associated battery, and whereby the processing ability determination section can perform a determination with great accuracy.

To achieve the above-mentioned objects, the present invention provides a first processing ability alteration instruction apparatus for instructing an alteration of a processing ability to an electronic apparatus to which a plurality of batteries are detachably mounted, comprising:

a removal requirement receipt section for receiving a removal requirement for a part of the batteries mounted on said electronic apparatus;

a processing ability determination section responsive to the removal requirement for a battery from said removal requirement receipt section for determining whether a supplying possible electric power from the remaining batteries only is an electric power capable of maintaining a processing ability or an electric power which needs to lower the processing ability; and

a processing ability alteration instruction section for instructing said electronic apparatus to lower the processing ability in accordance with a decision from said processing ability determination section that the electric power needs to lower the processing ability.

To achieve the above-mentioned objects, the present invention provides a second processing ability alteration instruction apparatus for instructing an alteration of a processing ability to an electronic apparatus to which a plurality of batteries are detachably mounted, comprising:

a removal requirement receipt section for receiving a removal requirement for a part of the batteries mounted on said electronic apparatus; and

a processing ability alteration instruction section responsive to the removal requirement for a battery from said removal requirement receipt section for instructing said electronic apparatus to lower the processing ability.

To achieve the above-mentioned objects, the present invention provides a third processing ability alteration instruction apparatus for instructing an alteration of a processing ability to an electronic apparatus to which a plurality of batteries are detachably mounted, comprising:

a mounting and removal detection section for detecting mounting and removal of batteries on and from said electronic apparatus; and

a processing ability alteration instruction section responsive to a detection of a removal of a battery by said mounting and removal detection section for instructing said electronic apparatus to lower the processing ability.

### BRIEF DESCRIPTION OF THE DRAWINGS

FIG. 1 is a schematic diagram of a notebook type of personal computer according to an embodiment of the present invention.

FIG. 2 is a block diagram showing an internal structure of the notebook type of personal computer shown in FIG. 1.

FIG. 3 is a block diagram showing a clock generation circuit of a processing apparatus shown in FIG. 2.

FIG. 4 is a view useful for understanding a memory map of a rewritable ROM providing in a battery pack.

FIG. 5 is a flowchart useful for understanding a residual electric power computing processing program showing processing of a residual electric power of a secondary battery in a battery pack, which processing is regularly executed.

FIG. 6 is a flowchart useful for understanding a residual electric power correcting program of correcting a residual electric power using a table showing the association between voltage value and current value and a residual electric power in ROM.

FIG. 7 is a flowchart useful for understanding a removal-acceptance decision program to be executed when any one of removal requirement buttons 102 shown in FIG. 1 is depressed.

FIG. 8 is a flowchart useful for understanding an alternative removal-acceptance decision program which may be adopted instead of the removal-acceptance decision program shown in FIG. 7.

FIG. 9 is a block diagram showing an alternative internal structure of the notebook type of personal computer, instead of the internal structure of the notebook type of personal computer shown in FIG. 2.

FIG. 10 is a flowchart useful for understanding an operational speed lowering program to be executed when any one of two battery packs shown in FIG. 9 is removed.

FIG. 11 is a block diagram showing a further alternative internal structure of the notebook type of personal computer, instead of the internal structure of the notebook type of personal computer shown in FIG. 2.

### DETAILED DESCRIPTION OF PREFERRED EMBODIMENTS

Embodiments of the present invention will be described with reference to the accompanying drawings.

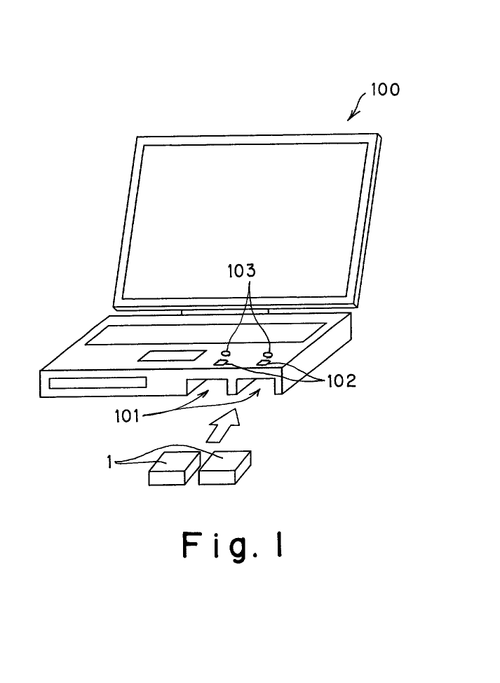

FIG. 1 is a schematic diagram of a notebook type of personal computer according to an embodiment of the present invention.

A notebook type of personal computer 100 is provided with two battery pack mounting slots 101. Two battery packs 1 are detachably mounted through the battery pack mounting slots 101. Further, on the top of the battery pack mounting slots 101 there are provided removal requirement buttons 102 each for requiring a removal of a battery mounted on the associated battery pack mounting slots 101. At positions adjacent to the removal requirement buttons 102 there are disposed indication sections 103 each for indicating inhibition or acceptance for removal of the associated battery pack 1.

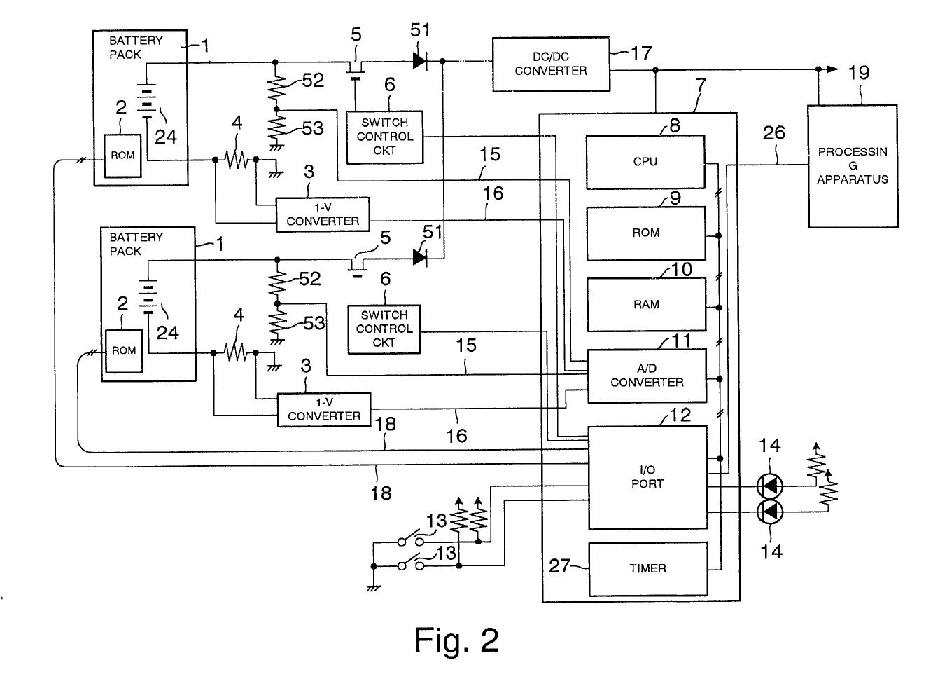

FIG. 2 is a block diagram showing an internal structure of the notebook type of personal computer shown in FIG. 1.

A processing apparatus 19 serves as a portion having an essential function of the notebook type of personal computer 100. FIG. 2 shows in detail a portion related to a removal of the battery packs 1.

Each of the two battery packs 1 is provided with a secondary battery 24 and a rewritable ROM 2 of which contents will be described later.

Electric powers supplied from the battery packs 1 are fed via switch transistors 5 and further via diodes 51 to a DC/DC converter 17. The DC/DC converter 17 converts the electric powers into electric powers of voltages to be used in internal circuits of the notebook type of personal computer 100. The electric powers thus converted are supplied to the internal circuit such as a microprocessor 7 and the processing apparatus 19.

The microprocessor 7 performs various controls related to mounting and removal of the battery packs 1. Execution of OS program and various application programs, which are of the essential function as the notebook type of personal computer 100, are performed by the processing apparatus 19, but not the microprocessor 7.

The microprocessor 7 comprises a CPU 8 for executing programs related to a treatment of the battery packs 1, a ROM 9 storing the programs to be executed by the CPU 8 and fixed data, a RAM 10 used as an working area when the programs are executed by the CPU 8, an A/D converter 11 for converting an analog signal to a digital signal to transmit the converted digital signal to the CPU 8 and the like, an I/O port 12 for input and output of digital signals, and a timer 27 for a clock.

Terminals of ground sides of the secondary batteries 24 provided on the battery packs 1 are grounded via current detection resistances 4. When the currents are supplied from the secondary batteries 24, voltage signals proportional to the supplied currents are taken via I/V converters 3, and the A/D converter 11 in the microprocessor 7. Each of both-end voltages of the secondary batteries 24 is divided by division resistances 52 and 53, and is taken via the signal line 15 and the A/D converter 11 in the microprocessor 7.

FIG. 2 shows two removal requirement switches 13 which turn on when the removal requirement buttons 102 shown in FIG. 1 are depressed. Turn-on and off information of the two removal requirement switches 13 is taken via the I/O port 12 in the microprocessor 7. The microprocessor 7 transmits via the I/O port 12 to switch control circuits 6 a control signal which causes switch transistors 5 to turn on or off. Each of the switch control circuits 6 controls turn-on or off of the associated switch transistor 5 in accordance with the control signal. While the switch control circuits 6 are omitted in FIGS. 1 and 2, the switch control circuits 6 serve to keep the switch transistors 5 in the turn-off so that electric powers of the secondary batteries 24 in the battery packs 1 are prevented from being consumed when the notebook type of personal computer 100 shown in FIG. 1 is operated by electric powers from the commercial power supplies and the like, and to keep switch transistors 5 in the turn-on when there is a need that the notebook type of personal computer 100 is operated by electric powers from the secondary batteries 24 in the battery packs 1.

Further, the microprocessor 7 transmits signals of turn-on and turn-off via the I/O port 12 to two LEDs 14. Each LED 14 turns on or off in accordance with the signal. Those two LEDs 14 are disposed on the two indication sections 103 shown in FIG. 1, respectively. The turn-on of the LED 14 indicates an acceptance of the removal of the associated battery pack 1.

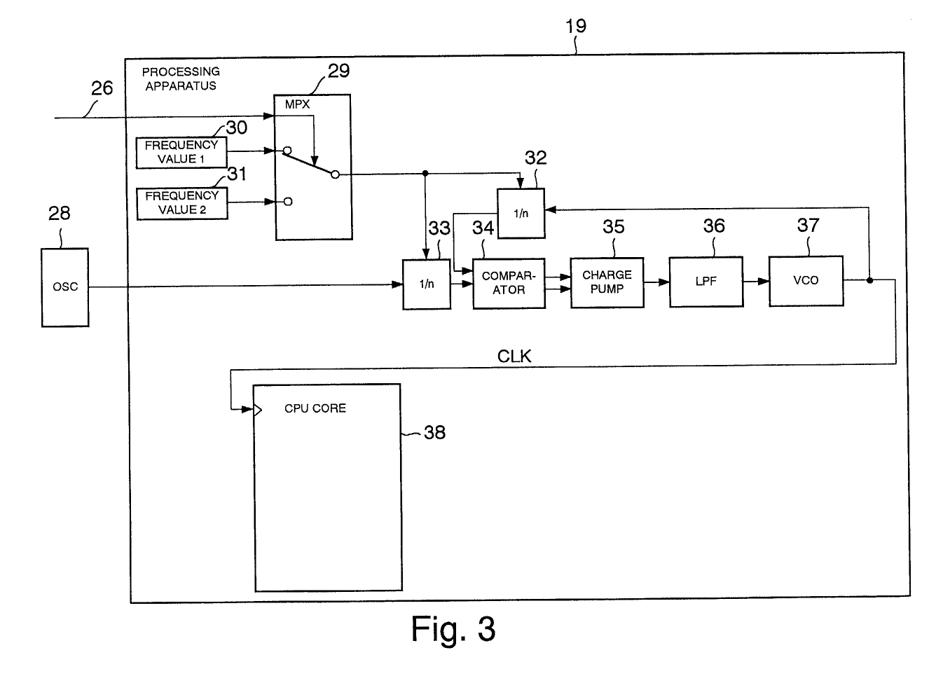

The processing apparatus 19 has, as will be described later referring to FIG. 3, a high speed processing mode for performing a high speed processing in synchronism with a clock which is high in a repetitive frequency, and a low speed processing mode for performing a low speed processing in synchronism with a clock which is low in a repetitive frequency. In the low speed processing mode, the processing apparatus 19 is operable in a consumed electric power which is lower as compared with the high speed processing mode.

The microprocessor 7 has a function of transmitting via the I/O port 12 and a signal line 26 a clock lowering request signal to instruct changing over to the low speed processing mode through lowering an operating clock.

FIG. 3 is a block diagram showing a clock generation circuit of the processing apparatus 19 shown in FIG. 2.

The processing apparatus 19 receives a main processing apparatus operating clock signal from an oscillator 28. This clock signal is fed to a processing apparatus core 38 in form of an operating clock CLK via a PLL circuit which comprises frequency dividers 32 and 33, a phase comparator 34, a charge pump 35, a low pass filter 36 and a voltage control oscillator 37. A repetitive frequency of the operating clock CLK for the processing apparatus core 38 is proportional to the processing ability and also the consumed electric power.

The operating clock CLK for the processing apparatus core 38 can be controlled by an alteration of dividing rate of the frequency dividers 32 and 33.

The processing apparatus 19 further comprises two frequency setting devices 30 and 31 for setting up mutually different clock frequencies. A multiplexer 29 sets up to the two frequency dividers 32 and 33 a frequency value from either one of the two frequency setting devices 30 and 31 in accordance with the clock lowering request signal transmitted via the signal line 26. The two frequency setting devices 30 and 31 output frequency values to be distributed to the frequency dividers 32 and 33.

Thus, the processing apparatus 19 makes it possible to control the operating speed (processing ability) in accordance with the clock lowering request signal, and thereby controlling the consumed electric power.

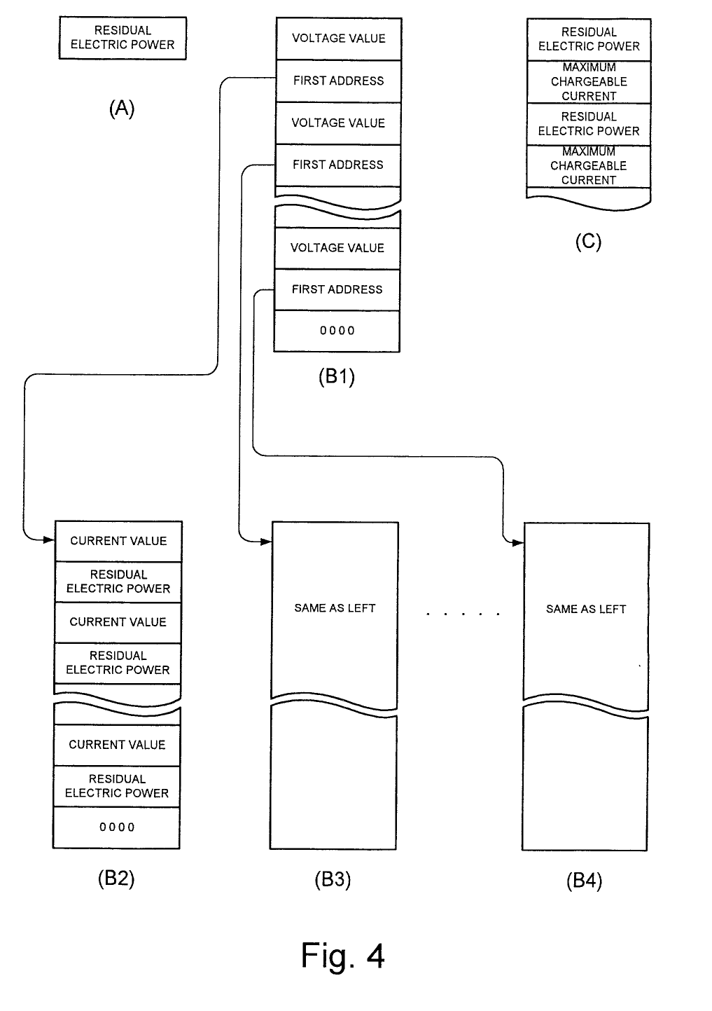

FIG. 4 is a view useful for understanding a memory map of the rewritable ROM providing in the battery pack 1.

FIG. 4 shows, classifying roughly, a residual electric power storage section (A) for storing the present residual electric power of the secondary batteries of the battery packs 1, tables (B1) to (B4) showing the relations between voltage values and current values and the residual electric powers, as characteristics of the secondary batteries, and a table (C) showing the relation between the residual electric power of the secondary batteries and the maximum chargeable electric power which can be derived from the secondary batteries involved in the residual electric power. The residual electric power storage section (A) is periodically rewritable in operation. Details of the memory map will be described hereinafter in conjunction with the following flowcharts.

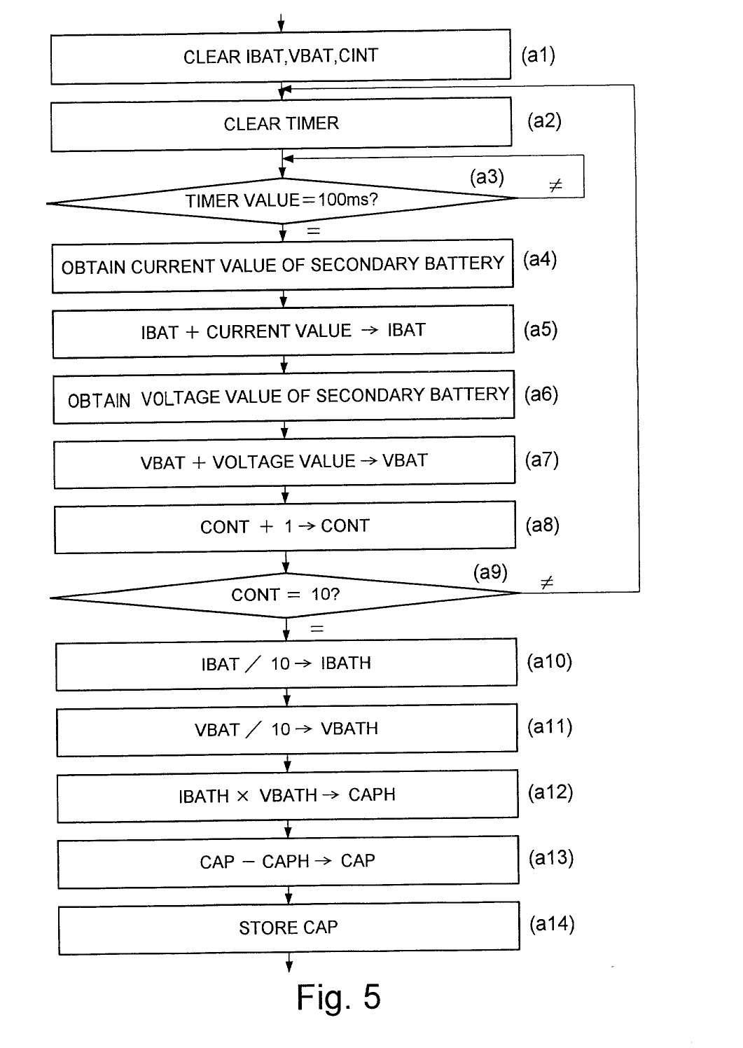

FIG. 5 is a flowchart useful for understanding a residual electric power computing processing program showing processing of residual electric power of the secondary battery 24 in the battery pack 1, which processing is regularly executed.

This flowchart is for computing the residual electric power of the secondary battery 24 in one of the two battery packs 1 shown in FIG. 2. Actually, the processing shown in FIG. 5 is performed for each of the two batteries.

First, IBAT, VBAT, CINT as the working areas are cleared into zero (step a1), and then a timer is reset to restart (step a2).

Next, when a timer value reaches 100 msec (step a3), the current value of the secondary battery 24 is derived from the I-V converter 3, and is accumulated to IBAT (steps a4, and a5).

A voltage of the secondary battery is obtained (step a6), the voltage value thus obtained is accumulated to VBAT (step a7), and a counter CONT is incremented by 1 (step a8).

In step a9, it is determined as to whether the counter CONT reaches counting value 10, while the above-mentioned measurement and accumulations of IBAT and VBAT are repeated until the counter CONT reaches counting value 10.

In the step a9, when it is decided that the counter CONT reaches counting value 10, IBAT and VBAT are subjected to a division by 10 to determine an average current and an average voltage, respectively, and the average current and the average voltage thus determined are stored in IBATH and VBATH, respectively (steps a10 and all). Further, the average current IBATH is multiplied by the average voltage VBATH to compute the present supplying power CAPH from the secondary battery (step a12). Thus, the supplying power CAPH of the secondary battery is subtracted from the previously determined residual electric power CAP to determine a new residual electric power CAP (step a13).

The new residual electric power CAP of the secondary battery thus determined is stored in the residual electric power storage section shown in part (A) of FIG. 4, of the rewritable ROM 2 of the battery pack 1 in which the secondary battery is incorporated (step a14).

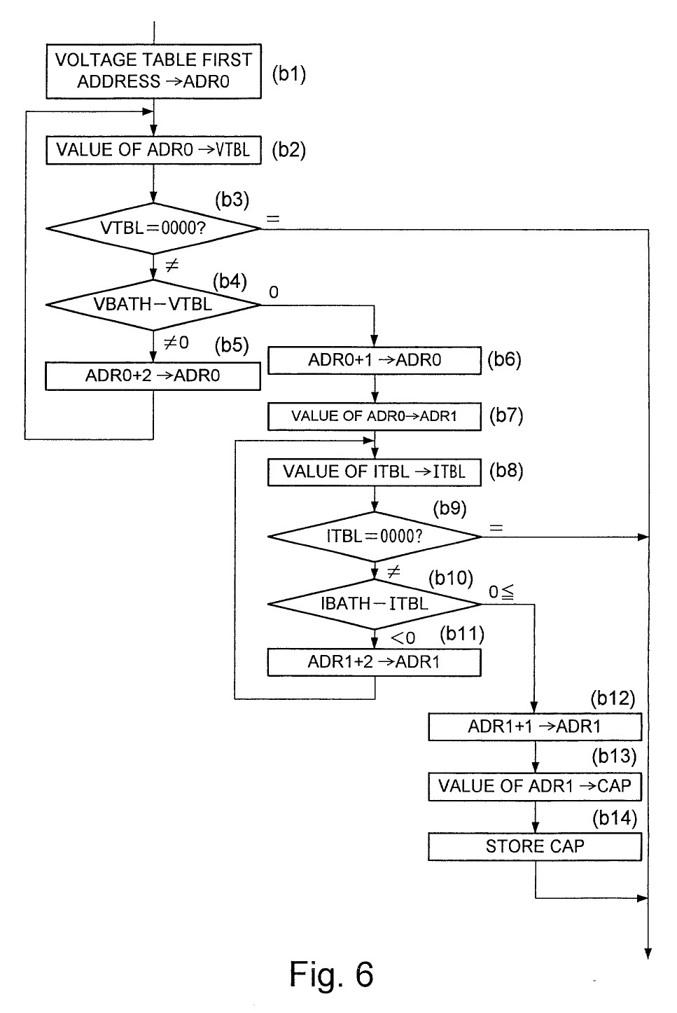

FIG. 6 is a flowchart useful for understanding a residual electric power correcting program of correcting a residual electric power using the tables (cf. parts (B1) to B(4) of FIG. 4) showing the association between voltage values and current values and the residual electric powers in the ROM 2. The residual electric power correcting program of FIG. 6 is regularly executed in a similar fashion to the residual electric power computing program of FIG. 5. FIG. 6 shows, in a similar fashion to that of FIG. 5, the flowchart involved in one of the two battery packs 1 shown in FIG. 2. Actually, the processing shown in FIG. 6 is performed for each of the two batteries.

First, the first address of the voltage table (part (B1) of FIG. 4) is set up to ADRO (step b1), and then the value (the voltage value) of ADRO is stored in VTBL (step b2). In step b3, it is determined whether VTBL is a table end code 0000 indicating the terminal of the voltage table (part (B1) of FIG. 4). When it is determined that VTBL is 0000 (VTBL=0000), the routine of FIG. 6 is passed through, since it is not a timing of correcting the residual electric power.

In the step b3, when VTBL is involved in a value other than a table end code 0000, the process goes to a step b4 in which the average voltage VBATH of the secondary battery, which is determined in the step a11, is compared with voltage value VTBL read out from the ROM 2, and it is determined as to whether those values are coincident with one another.

When those values are not coincident with one another, the address ADRO on the voltage table (part (B1) of FIG. 4) is incremented by 2 (step b5), and the processing of the steps b2 to b4 is repeated.

In the step b4, when it is decided that VBATH is coincident with VTBL (VBATH−VTBL=0), the process goes to a step b6 in which the address ADRO on the voltage table is incremented by 1, and the value stored in the address ADR0 after incremented, that is, the first address of the current tables (parts (B2) to (B4) of FIG. 4) is read. In step b7, the first address thus read is set to the address ADR1. The ROM 2 has a plurality of current tables associated with the voltage values of the voltage table of the part (B1) of FIG. 4. The subsequent addresses of the voltage values of each of the current tables store the first addresses of the voltage table associated with the voltage values, respectively. In the step b7, the first address of the current table associated with the voltage value VTBL coincident with the average voltage VBATH is stored in the address ADR1.

In a step b8, the value (current value) of the address ADR1 of the current table is read out and stored in ITBL. In a step b9, it is determined as to whether ITBL is the end code 0000. When it is decided that ITBL is the end code 0000, it means that the residual electric power to be corrected is not recorded in the current table, and thus the routine of FIG. 6 is passed through.

In the step b9, when it is decided that ITBL is not the end code 0000, the process goes to a step b10 in which the average current IBATH determined in the step a10 of FIG. 5 is compared with the current value ITBL determined from the current table. In the current tables shown in the parts (B2) to (B4) of FIG. 4, the current values are arranged in the order of smaller value. In the step b10, when the current value ITBL read out from the current table is equal to or more than the average current IBATH determined in the step a10 of FIG. 5 (IBATH−ITBL≦0), the process goes to a step b12. On the other hand, if not, the process goes to a step a11 in which the address ADR 1 on the current table is incremented by 2 (step b11), and the processing of the steps b8 to b10 is repeated.

In the step b12, the address ADR 1 on the current table is incremented by 1, and the value of the address ADR 1 after incremented is read out and then stored in CAP (step b13). The current tables of the parts (B2) to (B4) of FIG. 4 store therein the current values and the associated residual electric powers in pairs alternately. In the step b13, the residual electric power associated with the current value of the secondary battery is determined.

In this manner, the residual electric powers CAP, which are determined from the tables of the parts (B2) to (B4) of FIG. 4 stored in ROM2 of the battery pack 1, are stored in the residual electric power storage section shown in part (A) of FIG. 4 in the ROM2.

That is, usually, the average current IBATH and the average voltage VBATH are determined in accordance with the flow of FIG. 5 (steps a10 and a11), and the residual electric power CAP is determined by the multiplication of the average current IBATH and the average voltage VBATH (step a12) and then stored in the ROM 2. In a timing that the average voltage VBATH is coincident with any one of the plurality of voltage values stored in the voltage table (part (B1) of FIG. 4), the residual electric power stored in the ROM 2 is replaced by the residual electric power read out from the current tables (parts (B2) to (B4) of FIG. 4).

Those processings are performed for each of the two battery packs shown in FIG. 2.

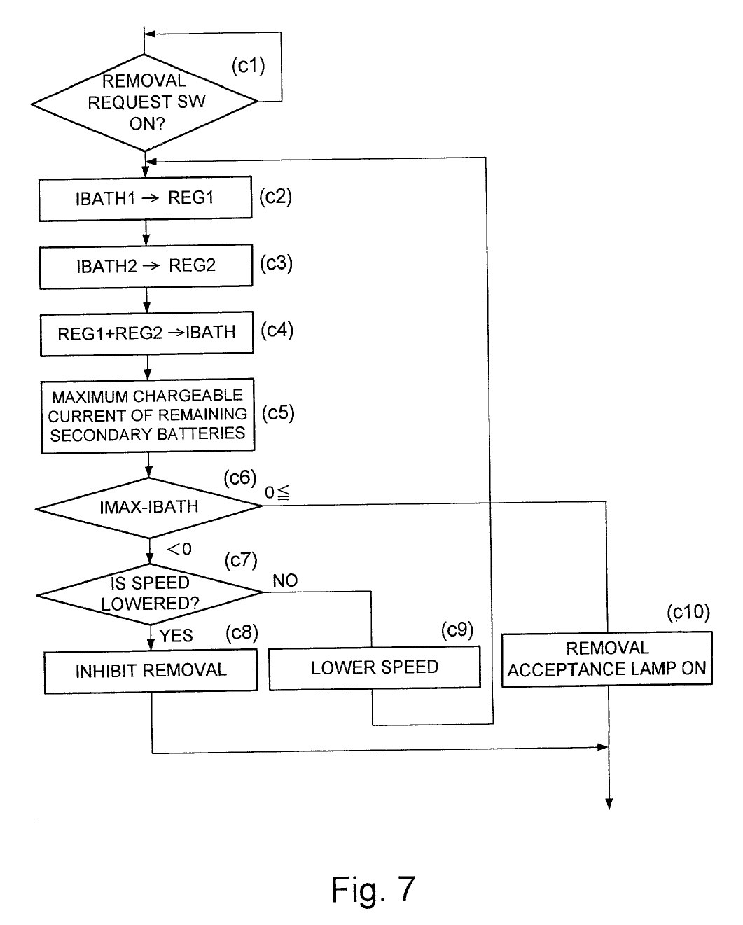

FIG. 7 is a flowchart useful for understanding a removal-acceptance decision program to be executed when any one of removal requirement buttons 102 shown in FIG. 1 is depressed.

When any one of the two removal requirement buttons 102 shown in FIG. 1 is depressed, any one of the two removal requirement switches 13 shown in FIG. 2 turns on, so that the turn-on signal is transmitted via the I/O port 12 to the microprocessor 7. In a step c1 of FIG. 7, it is monitored as to whether any one of the two removal requirement switches 13 shown in FIG. 2 turns on. When the turn-on of any one of the two removal requirement switches 13 is detected, the average currents IBATH 1 and IBATH 2 of the two batteries 24 of the two battery packs 1 shown in FIG. 2 are stored in REG 1 and REG 2, respectively (steps c2 and c3). Thus, the additional value of those currents, that is, all the supplying current IBATH supplied from both the battery packs 1 is determined (step c4). In a step c5, the maximum chargeable current of the secondary battery of the remaining battery pack, other than the secondary battery of the battery pack requested for the removal, is stored in IMAX (step c5). The maximum chargeable current, which corresponds to the residual electric power stored in the residual electric power storage section, is determined in such a manner that the residual electric power stored in the residual electric power storage section shown in the part (A) of FIG. 4, in the ROM2 is read out, and then the association table between the residual electric power shown in the part (C) of FIG. 4 and the maximum chargeable current is referred to.

In a step c6, the maximum chargeable current IMAX determined from the table shown in the part (C) of FIG. 4 is compared with the all supplying current IBATH determined in the step c4. In the event that it is decided that the maximum chargeable current IMAX is larger (0≦IMAX−IBATH), of the two removal requirement buttons 102 (cf. FIG. 1), the removal acceptance lamp associated with the depressed removal request button is turned on (LED 14 in FIG. 2 is illuminated) (step c10).

In the step c6, when it is decided that the all supplying current IBATH is larger than the maximum chargeable current IMAX (IMAX−IBATH<0), the process goes to a step c7 in which it is determined as to whether the operation speed of the processing apparatus 19 is already lowered (the above-mentioned low speed processing mode). In the event that the operation speed is in a state of the high speed (the high speed processing mode), the process goes to a step c8 in which the clock lowering request signal is outputted to the processing apparatus 19. Upon receipt of the clock lowering request signal, the processing apparatus 19 changes over the operation clock CLK (cf. FIG. 3) to a clock of the low speed.

Next, the process returns to the step c2 so that the all supplying current IBATH is determined in a state that the operation clock CLK is changed over to the clock of the low speed. In the step c6, when it is decided that the maximum chargeable current IMAX is equal to or above the all supplying current IBATH (0≦IMAX−IBATH) the process goes to the step c10 in which the removal acceptance lump (LED 14) turns on.

On the other hand, also in the low speed processing mode, when it is decided that the all supplying current IBATH is larger than the maximum chargeable current IMAX (IMAX−IBATH<0), the process goes via the step c7 to a step c9 in which the removal inhibit offers (LED 14 maintains turn-off).

Thus, turn-on or off of the LED makes it possible for a user of the notebook type of personal computer 100 shown in FIG. 1 to determine whether the battery 1 requested in removal may be removed. When the user determines that the battery 1 should not be removed, the user saves the present data and the like of the notebook type of personal computer 100 for example into a magnetic disk, a floppy disk, etc., which are not illustrated, and turns off the power supply of the notebook type of personal computer 100. Thereafter, it is permitted to remove the battery.

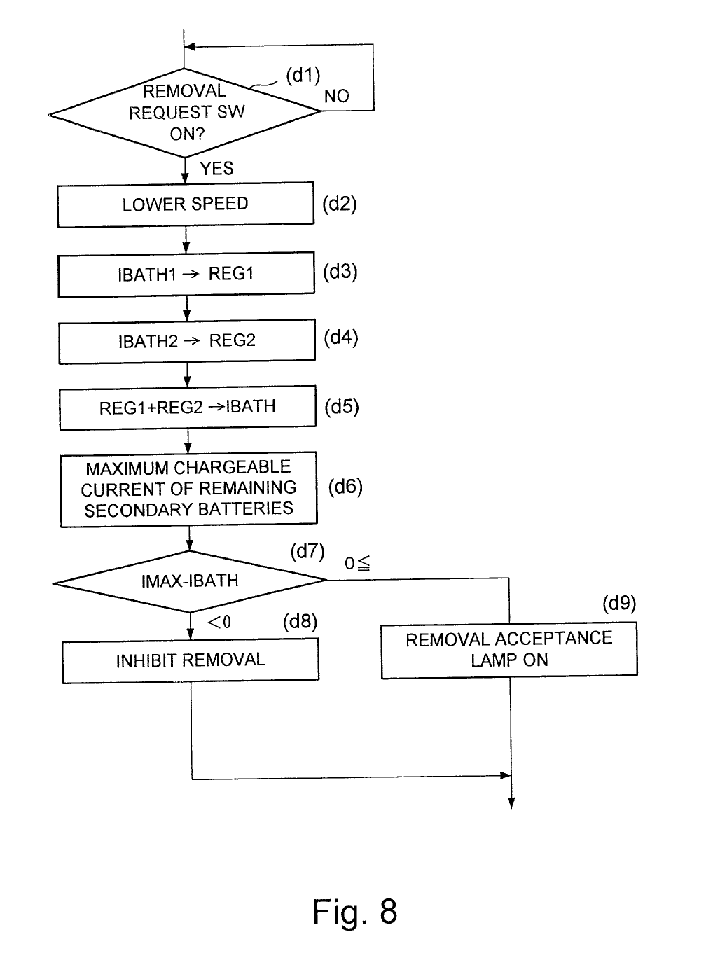

FIG. 8 is a flowchart useful for understanding an alternative removal-acceptance decision program which may be adopted instead of the removal-acceptance decision program shown in FIG. 7.

In case of the removal-acceptance decision program of FIG. 8, when the removal request switch turns on (step d1), the clock lowering request signal is immediately outputted to the processing apparatus 19 so that the operation clock CLK of the processing apparatus 19 is changed over to an operation clock lower in a repetitive frequency (step d2).

The subsequent steps d3 to d7 are the same as those of the steps c2 to c6 in FIG. 7. Thus, the redundant explanation will be omitted.

According as the maximum chargeable current IMAX is equal to or above the all supplying current IBATH (0≦IMAX−IBATH), the removal acceptance lamp (LED 14) associated with the depressed removal request button is turned on (step d9), or the removal inhibit offers (LED 14 maintains turn-off) (step d8).

According to the removal-acceptance decision program of FIG. 7 or FIG. 8, upon receipt of the removal request, as an occasion arises (in case of FIG. 7), or in the same way (in case of FIG. 8), the operation clock CLK of the processing apparatus 19 is lowered to contribute to a decrease of the consumed electric power. Thus, it is possible to use, as the secondary battery 24 in the battery pack 1, a lower capacity of one as compared with the conventional one, and thereby providing a more compact notebook type of personal computer 100.

Further, according to the removal-acceptance decision program of FIG. 7 or FIG. 8, the use of the removal-acceptance lamp (LED 14) indicates the acceptance of the removal of the battery by illuminating the removal-acceptance lamp (LED 14). Thus, this feature makes it possible for an operator to easily know whether it is permitted to remove the battery pack required in removal in operation of the notebook type of personal computer.

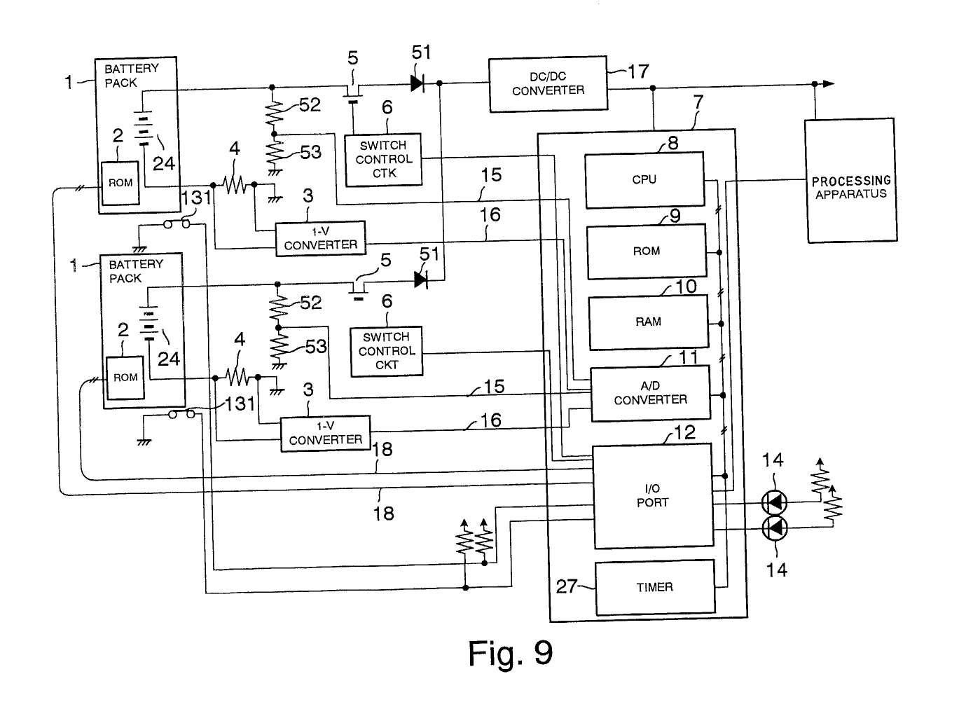

FIG. 9 is a block diagram showing an alternative internal structure of the notebook type of personal computer, instead of the internal structure of the notebook type of personal computer shown in FIG. 2.

A difference between the notebook type of personal computer shown in FIG. 4 and the notebook type of personal computer shown in FIG. 2 resides in the point that the notebook type of personal computer shown in FIG. 4 is provided with mounting switches 131, which turn on when the battery packs 1 are mounted, and turns off when the battery packs 1 are removed, instead of the removal requirement switches 13 which turn on when the removal requirement buttons 102 are depressed. Thus, the notebook type of personal computer shown in FIG. 4 offers the outside appearance (not illustrated) in which the removal requirement buttons 102 is removed from the notebook type of personal computer 100 shown in FIG. 1.

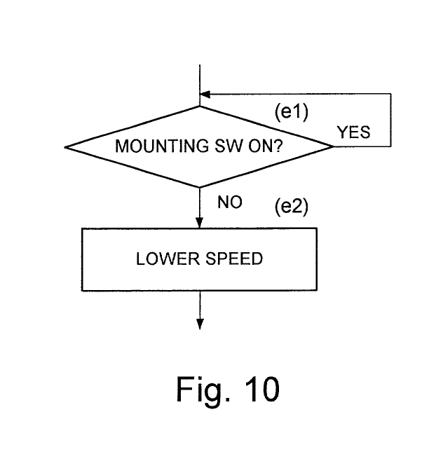

FIG. 10 is a flowchart useful for understanding an operational speed lowering program to be executed when any one of two battery packs 1 shown in FIG. 9 is removed.

Here, it is monitored whether both the mounting switches 131 are turned on, or one of the mounting switches 131 is turned off (step e1). When any one of the mounting switches 131 is turned off, the clock lowering request signal is outputted, so that the repetitive frequency of the operational clock of the processing apparatus 19 is lowered (step e2).

In this manner, it is possible to reduce a possibility of an unstable operation of the notebook type of personal computer, when a part of a plurality of battery packs is suddenly removed.

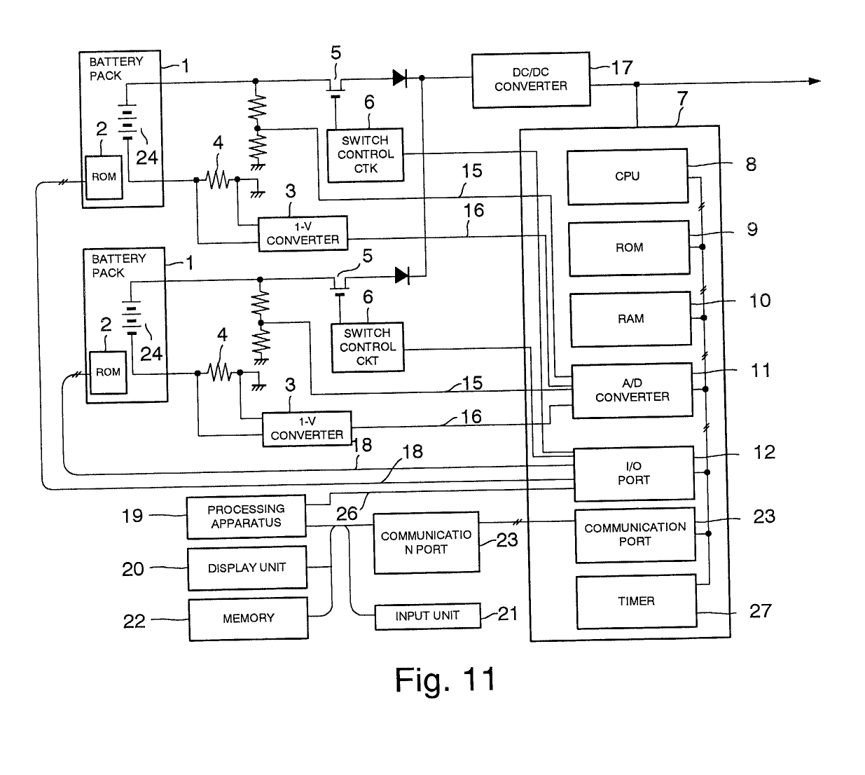

FIG. 11 is a block diagram showing a further alternative internal structure of the notebook type of personal computer, instead of the internal structure of the notebook type of personal computer shown in FIG. 2.

The notebook type of personal computer associated with the internal structure shown in FIG. 11 offers the outside appearance (not illustrated) in which the removal requirement buttons 102 and the indication sections 103 are removed from the notebook type of personal computer 100 shown in FIG. 1.

In FIG. 11, the two removal requirement switches 13 and the LEDs 14 are omitted shown in FIG. 2. Instead, there are provided communication ports 23 on the microprocessor 7 and the processing apparatus 19, respectively. While FIG. 11 shows a display unit 20, an input unit 21, and a memory 22, those elements are simply omitted in illustration of FIG. 2, and are not new structural elements. That is, the display unit 20 serves as a display of the notebook type of personal computer including for example a liquid crystal display screen, as shown in FIG. 1, the input unit 21 serves as an input unit such as a keyboard, and the memory 22 serves as a magnetic disk and other memories (not illustrated), which constitute the notebook type of personal computer.

According to the present embodiment, a predetermined key operation of the input unit 21 such as the keyboard corresponds to the removal requirement button. The removal requirement performed through the key operation is transmitted via the communication port 23 to the microprocessor 7. In the event that the removal acceptance program shown in FIG. 5 or FIG. 6 is executed by the microprocessor 7 and as a result the removal acceptance is decided, the removal acceptance signal is transmitted via the communication port 23 to the processing apparatus 19, so that it is displayed on the display screen of the display unit 20 that the removal is accepted.

According to the structure shown in FIG. 11, there is no need to provide in appearance especial buttons and display units on the notebook type of personal computer. Thus, it is possible to incorporate the functions of the present invention into the notebook type of personal computer, without giving a user a feeling of wrongness.

While the above-mentioned embodiments raise by way of example the notebook type of personal computer, an electronic apparatus of the present invention is not restricted to the notebook type of personal computer, and is applicable to any types of electronic apparatus, information processing apparatus, and a mobile type of terminal equipment operative by batteries and a portable telephone.

As mentioned above, according to the present invention, it is possible to use a battery which is lower in a current supplying ability as compared with the conventional one, and thereby contributing to a compactness, a weight saving, and a cost-down.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An electronic apparatus to which a plurality of batteries are detachably mounted, comprising:
a removal requirement receipt section for receiving a removal requirement for a part of the mounted batteries;
a processing ability determination section responsive to the removal requirement for a battery from said removal requirement receipt section for determining whether a supplying possible electric power from the remaining batteries is an electric power capable of maintaining a processing ability or an electric power which needs to lower the processing ability; and
a processing ability control section for lowering the processing ability in accordance with a decision from said processing ability determination section that the electric power needs to lower the processing ability.

2. An electronic apparatus to which a plurality of batteries are detachably mounted, comprising:
a removal requirement receipt section for receiving a removal requirement for a part of the mounted batteries; and
a processing ability control section responsive to the removal requirement for a battery from said removal requirement receipt section for lowering a processing ability.

3. An electronic apparatus to which a plurality of batteries are detachably mounted, comprising:
a mounting and removal detection section for detecting mounting and removal of batteries; and
a processing ability control section responsive to a detection of a removal of a battery by said mounting and removal detection section for lowering a processing ability.

4. An electronic apparatus according to claim 1, in which said electronic apparatus has a portion receiving a clock and operative in synchronism with the clock while consuming an electronic power according to a repetitive frequency of the clock,
wherein said processing ability control section changes over the frequency of the clock to control the processing ability.

5. An electronic apparatus according to claim 2, in which said electronic apparatus has a portion receiving a clock and operative in synchronism with the clock while consuming an electronic power according to a repetitive frequency of the clock,
wherein said processing ability control section changes over the frequency of the clock to control the processing ability.

6. An electronic apparatus according to claim 3, in which said electronic apparatus has a portion receiving a clock and operative in synchronism with the clock while consuming an electronic power according to a repetitive frequency of the clock,
wherein said processing ability control section changes over the frequency of the clock to control the processing ability.

7. An electronic apparatus according to claim 1, wherein said processing ability determination section receives the removal requirement for a battery from said removal requirement receipt section and determines whether an electric power supplying ability is insufficient with only the remaining batteries, even if the processing ability is lowered by said processing ability control section, and
said electronic apparatus further comprises a removal acceptance display section for displaying inhibit or acceptance of the removal of a battery according as said processing ability determination section determines whether an electric power supplying ability is insufficient with only the remaining batteries, even if the processing ability is lowered by said processing ability control section.

8. An electronic apparatus according to claim 2, further comprising:
a processing ability determination section responsive to the removal requirement for a battery from said removal requirement receipt section for determining whether an electric power supplying ability is insufficient with only the remaining batteries, even if the processing ability is lowered by said processing ability control section, and
a removal acceptance display section for displaying inhibit or acceptance of the removal of a battery according as said processing ability determination section determines whether an electric power supplying ability is insufficient with only the remaining batteries, even if the processing ability is lowered by said processing ability control section.

9. An electronic apparatus according to claim 1, further comprising a residual electric power monitor section for monitoring a residual electric power of the mounted batteries.

10. An electronic apparatus according to claim 2, further comprising a residual electric power monitor section for monitoring a residual electric power of the mounted batteries.

11. An electronic apparatus according to claim 9, wherein said residual electric power monitor section measures voltage and supplying current of the mounted batteries and determines a residual electric power of the batteries through an arithmetic operation.

12. An electronic apparatus according to claim 10, wherein said residual electric power monitor section measures voltage and supplying current of the mounted batteries and determines a residual electric power of the batteries through an arithmetic operation.

13. An electronic apparatus according to claim 1, wherein each of said batteries is a chargeable secondary battery provided in a battery pack, and a plurality of such battery packs are capable of being mounted on said electronic apparatus.

14. An electronic apparatus according to claim 2, wherein each of said batteries is a chargeable secondary battery provided in a battery pack, and a plurality of such battery packs are capable of being mounted on said electronic apparatus.

15. An electronic apparatus according to claim 3, wherein each of said batteries is a chargeable secondary battery provided in a battery pack, and a plurality of such battery packs are capable of being mounted on said electronic apparatus.

16. An electronic apparatus according to claim 1, wherein each of said batteries is a battery provided in a battery pack, a plurality of such battery packs are capable of being mounted on said electronic apparatus, and each of said battery packs has a memory for storing a residual electric power of a battery of an associated battery pack.

17. An electronic apparatus according to claim 2, wherein each of said batteries is a battery provided in a battery pack, a plurality of such battery packs are capable of being mounted on said electronic apparatus, and each of said battery packs has a memory for storing a residual electric power of a battery of an associated battery pack.

18. An electronic apparatus according to claim 9, wherein each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and
wherein said residual electric power monitor section measures voltage and supplying current of the mounted batteries and determines a residual electric power of the batteries referring to said memories.

19. An electronic apparatus according to claim 10, wherein each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and
wherein said residual electric power monitor section measures voltage and supplying current of the mounted batteries and determines a residual electric power of the batteries referring to said memories.

20. An electronic apparatus according to claim 11, wherein each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and
wherein said residual electric power monitor section measures voltage and supplying current of the mounted batteries and determines a residual electric power of the batteries referring to said memories.

21. An electronic apparatus according to claim 12, wherein each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and
wherein said residual electric power monitor section measures voltage and supplying current of the mounted batteries and determines a residual electric power of the batteries referring to said memories.

22. An electronic apparatus according to claim 1, wherein each of said batteries is a battery provided in a battery pack, a plurality of such battery packs are capable of being mounted on said electronic apparatus, and each of said battery packs has a memory for storing an association between a residual electric power of an associated battery and a maximum chargeable current, and
wherein said processing ability determination section performs a determination referring to said memories.

23. An electronic apparatus according to claim 7, wherein each of said batteries is a battery provided in a battery pack, a plurality of such battery packs are capable of being mounted on said electronic apparatus, and each of said battery packs has a memory for storing an association between a residual electric power of an associated battery and a maximum chargeable current, and
wherein said processing ability determination section performs a determination referring to said memories.

24. An electronic apparatus according to claim 8, wherein each of said batteries is a battery provided in a battery pack, a plurality of such battery packs are capable of being mounted on said electronic apparatus, and each of said battery packs has a memory for storing an association between a residual electric power of an associated battery and a maximum chargeable current, and
wherein said processing ability determination section performs a determination referring to said memories.

25. A processing ability alteration instruction apparatus for instructing an alteration of a processing ability to an electronic apparatus to which a plurality of batteries are detachably mounted, comprising:
a removal requirement receipt section for receiving a removal requirement for a part of the batteries mounted on said electronic apparatus;
a processing ability determination section responsive to the removal requirement for a battery from said removal requirement receipt section for determining whether a supplying possible electric power from the remaining batteries only is an electric power capable of maintaining a processing ability or an electric power which needs to lower the processing ability; and
a processing ability alteration instruction section for instructing said electronic apparatus to lower the processing ability in accordance with a decision from said processing ability determination section that the electric power needs to lower the processing ability.

26. A processing ability alteration instruction apparatus for instructing an alteration of a processing ability to an electronic apparatus to which a plurality of batteries are detachably mounted, comprising:
a removal requirement receipt section for receiving a removal requirement for a part of the batteries mounted on said electronic apparatus; and
a processing ability alteration instruction section responsive to the removal requirement for a battery from said removal requirement receipt section for instructing said electronic apparatus to lower the processing ability.

27. A processing ability alteration instruction apparatus for instructing an alteration of a processing ability to an electronic apparatus to which a plurality of batteries are detachably mounted, comprising:
a mounting and removal detection section for detecting mounting and removal of batteries on and from said electronic apparatus; and
a processing ability alteration instruction section responsive to a detection of a removal of a battery by said mounting and removal detection section for instructing said electronic apparatus to lower the processing ability.

28. A processing ability alteration instruction apparatus according to claim 25, wherein said processing ability determination section receives the removal requirement for a battery from said removal requirement receipt section and determines whether an electric power supplying ability is insufficient with only the remaining batteries, even if the processing ability of said electronic apparatus is lowered, and
said processing ability alteration instruction apparatus further comprises a removal acceptance display section for displaying inhibit or acceptance of the removal of a battery according as said processing ability determination section determines whether an electric power supplying ability is insufficient with only the remaining batteries, even if the processing ability is lowered.

29. A processing ability alteration instruction apparatus according to claim 26, further comprising:
a processing ability determination section responsive to the removal requirement for a battery from said removal requirement receipt section for determining whether an electric power supplying ability is insufficient with only the remaining batteries, even if the processing ability of said electronic apparatus is lowered, and
a removal acceptance display section for displaying inhibit or acceptance of the removal of a battery according as said processing ability determination section determines whether an electric power supplying ability is insufficient with only the remaining batteries, even if the processing ability of said electronic apparatus is lowered.

30. A processing ability alteration instruction apparatus according to claim 25, further comprising a residual electric power monitor section for monitoring a residual electric power of the mounted batteries.

31. A processing ability alteration instruction apparatus according to claim 26, further comprising a residual electric power monitor section for monitoring a residual electric power of the mounted batteries.

32. A processing ability alteration instruction apparatus according to claim 30, wherein said residual electric power monitor section measures voltage and supplying current of the mounted batteries and determines a residual electric power of the batteries through an arithmetic operation.

33. A processing ability alteration instruction apparatus according to claim 31, wherein said residual electric power monitor section measures voltage and supplying current of the mounted batteries and determines a residual electric power of the batteries through an arithmetic operation.

34. A processing ability alteration instruction apparatus according to claim 25, wherein each of said batteries is a battery provided in a battery pack, a plurality of such battery packs are capable of being mounted on said electronic apparatus, and each of said battery packs has a memory for storing a residual electric power of a battery of an associated battery pack.

35. A processing ability alteration instruction apparatus according to claim 26, wherein each of said batteries is a battery provided in a battery pack, a plurality of such battery packs are capable of being mounted on said electronic apparatus, and each of said battery packs has a memory for storing a residual electric power of a battery of an associated battery pack.

36. A processing ability alteration instruction apparatus according to claim 30, wherein each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and
wherein said residual electric power monitor section measures voltage and supplying current of the mounted batteries and determines a residual electric power of the batteries referring to said memories.

37. A processing ability alteration instruction apparatus according to claim 31, wherein each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and
wherein said residual electric power monitor section measures voltage and supplying current of the mounted batteries and determines a residual electric power of the batteries referring to said memories.

38. A processing ability alteration instruction apparatus according to claim 32, wherein each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and
wherein said residual electric power monitor section measures voltage and supplying current of the mounted batteries and determines a residual electric power of the batteries referring to said memories.

39. A processing ability alteration instruction apparatus according to claim 33, wherein each of said batteries is a battery provided in a battery pack, a plurality of such battery packs are capable of being mounted on said electronic apparatus, and each of said battery packs has a memory for storing an association between voltage and supplying current of an associated battery and a residual electric power of the battery, and
wherein said residual electric power monitor section measures voltage and supplying current of the mounted batteries and determines a residual electric power of the batteries referring to said memories.

40. A processing ability alteration instruction apparatus according to claim 25, wherein each of said batteries is a battery provided in a battery pack, a plurality of such battery packs are capable of being mounted on said electronic apparatus, and each of said battery packs has a memory for storing an association between a residual electric power of an associated battery and a maximum chargeable current, and
wherein said processing ability determination section performs a determination referring to said memories.

41. A processing ability alteration instruction apparatus according to claim 28, wherein each of said batteries is a battery provided in a battery pack, a plurality of such battery packs are capable of being mounted on said electronic apparatus, and each of said battery packs has a memory for storing an association between a residual electric power of an associated battery and a maximum chargeable current, and
wherein said processing ability determination section performs a determination referring to said memories.

42. A processing ability alteration instruction apparatus according to claim 29, wherein each of said batteries is a battery provided in a battery pack, a plurality of such battery packs are capable of being mounted on said electronic apparatus, and each of said battery packs has a memory for storing an association between a residual electric power of an associated battery and a maximum chargeable current, and
wherein said processing ability determination section performs a determination referring to said memories.
